(19) United States
(12) Patent Application Publication
(10) Pub. No.: US 2022/0214704 A1
(43) Pub. Date: Jul. 7, 2022

(54) UNMANNED AERIAL VEHICLE CONTROL METHOD AND UNMANNED AERIAL VEHICLE

(71) Applicant: SZ DJI TECHNOLOGY CO., LTD., Shenzhen (CN)

(72) Inventors: Liangliang YANG, Shenzhen (CN); Ming CHEN, Shenzhen (CN)

(21) Appl. No.: 17/513,464

(22) Filed: Oct. 28, 2021

Related U.S. Application Data
(63) Continuation of application No. PCT/CN2019/085087, filed on Apr. 30, 2019.

(51) Int. Cl. G05D 1/10; B64C 39/02; G08G 5/00; G08G 5/04

(52) U.S. Cl. CPC G05D 1/1064; B64C 39/024; B64C 2201/14; G08G 5/04; G08G 5/0008

(57) ABSTRACT

A method for controlling an unmanned aerial vehicle includes obtaining flight status information of a target aircraft, determining a relative direction of the target aircraft relative to the unmanned aerial vehicle according to the flight status information of the target aircraft, and communicatively connecting an automatic dependent surveillance broadcast (ADS-B) device of the unmanned aerial vehicle to a target antenna selected from a plurality of antennas of the unmanned aerial vehicle according to the relative direction and radiation patterns of the plurality of antennas, so that the ADS-B device obtains and analyzes an ADS-B signal from the target aircraft received by the target antenna. The radiation patterns of the plurality of antennas are different from each other.

### CROSS-REFERENCE TO RELATED APPLICATION

This application is a continuation of International Application No. PCT/CN2019/085087, filed Apr. 30, 2019, the entire content of which is incorporated herein by reference.

### TECHNICAL FIELD

The present disclosure relates to the technical field of unmanned aerial vehicle and, more particularly, to an unmanned aerial vehicle control method and an unmanned aerial vehicle.

### BACKGROUND

When an unmanned aerial vehicle is flying in air, if the unmanned aerial vehicle can obtain information about surrounding aircraft in real time, measures can be taken as soon as possible to avoid collision. At present, an automatic dependent surveillance broadcast (ADS-B) device is mounted at an aircraft (such as a civil aviation passenger aircraft, a small operation aircraft, some unmanned aerial vehicles, etc.), and the ADS-B device can broadcast ADS-B information such as longitude, latitude, altitude, speed, or heading of the aircraft itself in real time. The unmanned aerial vehicle is provided with an antenna and the corresponding ADS-B device connected to the antenna. The antenna can receive an ADS-B signal broadcasted by the ADS-B device of the aircraft, and the ADS-B device obtains the ADS-B information broadcasted by the ADS-B device of the aircraft from the antenna. The unmanned aerial vehicle controls the unmanned aerial vehicle or prompts warning information to a ground user according to the information received by the ADS-B device, so as to avoid collision between the unmanned aerial vehicle and the aircraft. However, the antenna cannot achieve ideal omnidirectionality, which may cause the antenna to fail to receive or continuously receive the ADS-B signal from the aircraft in certain directions. As such, the ADS-B at the unmanned aerial vehicle cannot obtain flight status information of the aircraft, thereby increasing risk of collision between the unmanned aerial vehicle and the aircraft.

### SUMMARY

In accordance with the disclosure, there is provided a method for controlling an unmanned aerial vehicle including obtaining flight status information of a target aircraft, determining a relative direction of the target aircraft relative to the unmanned aerial vehicle according to the flight status information of the target aircraft, and communicatively connecting an automatic dependent surveillance broadcast (ADS-B) device of the unmanned aerial vehicle to a target antenna selected from a plurality of antennas of the unmanned aerial vehicle according to the relative direction and radiation patterns of the plurality of antennas, so that the ADS-B device obtains and analyzes an ADS-B signal from the target aircraft received by the target antenna. The radiation patterns of the plurality of antennas are different from each other.

Also in accordance with the disclosure, there is provided an unmanned aerial vehicle including a plurality of antennas, an automatic dependent surveillance broadcast (ADS-B) device configured to analyze an ADS-B signal from a target aircraft to obtain flight status information of the target aircraft, and a processor configured to obtain the flight status information of the target aircraft, determine a relative direction of the target aircraft relative to the unmanned aerial vehicle according to the flight status information of the target aircraft, and communicatively connect the ADS-B device to a target antenna of the plurality of antennas according to the relative direction and radiation patterns of the plurality of antennas, so that the ADS-B device obtains and analyzes the ADS-B signal from the target aircraft received by the target antenna.

The radiation patterns of the plurality of antennas are different from each other.

### BRIEF DESCRIPTION OF THE DRAWINGS

In order to explain the embodiments of the present disclosure or the technical solutions in the existing technology more clearly, reference is made to the accompanying drawings, which are used in the description of the embodiments. Obviously, the drawings in the following description are some embodiments of the present disclosure, and other drawings can be obtained from these drawings without any inventive effort for those of ordinary skill in the art.

FIG. 1 is a schematic architecture diagram of an unmanned aerial system according to the present disclosure.

FIG. 2 is a flow chart of an unmanned aerial vehicle control method according to an embodiment of the present disclosure.

FIG. 3 is a schematic diagram showing an antenna and an ADS-B device carried by an unmanned aerial vehicle according to an embodiment of the present disclosure.

FIG. 4 is a schematic diagram showing signal frames of an ADS-B signal based on a UAT protocol according to an embodiment of the present disclosure.

FIG. 5 is a flow chart of an unmanned aerial vehicle control method according to another embodiment of the present disclosure.

FIG. 6 is a schematic diagram showing an antenna and an ADS-B device carried by an unmanned aerial vehicle according to another embodiment of the present disclosure.

FIG. 7 is a schematic structural diagram of an unmanned aerial vehicle according to an embodiment of the present disclosure.

FIG. 8 is a schematic structural diagram of an unmanned aerial vehicle according to another embodiment of the present disclosure.

### DETAILED DESCRIPTION OF THE EMBODIMENTS

In order to make the objectives, technical solutions, and advantages of the embodiments of the present disclosure clearer, the technical solutions in the embodiments of the present disclosure will be clearly described in combination with the accompanying drawings. Obviously, the described embodiments are some of rather than all the embodiments of the present disclosure. All other embodiments obtained by those of ordinary skill in the art based on the embodiments of the present disclosure without inventive effort shall fall within the scope of the present disclosure.

It should be noted that when a component is referred to as being “fixed to” another component, it can be directly attached to the other component or an intervening component may also exist. When a component is considered to be “connected” to another component, it can be directly connected to the other component or an intervening component may exist at the same time.

Unless otherwise defined, all technical and scientific terms used herein have the same meaning as commonly understood by those skilled in the technical field of the present disclosure. The terms used in the description of the present disclosure herein are for the purpose of describing specific embodiments only and are not intended to limit the present disclosure. The term “and/or” as used herein includes any and all combinations of one or more associated items that are listed.

Hereinafter, some embodiments of the present disclosure will be described in detail with reference to the accompanying drawings. In the case of no conflict, the following embodiments and features in the embodiments can be combined with each other.

The present disclosure provides an unmanned aerial vehicle control method and an unmanned aerial vehicle. The following description of the present disclosure uses the unmanned aerial vehicle as an example. It will be obvious to those skilled in the art that other types of unmanned aerial vehicles may be used without limitation, and the embodiments of the present disclosure may be applied to various types of unmanned aerial vehicles. For example, the unmanned aerial vehicle may be a small or large unmanned aerial vehicle. In some embodiments, the unmanned aerial vehicle may be a rotorcraft, such as a multi-rotor aircraft propelled by a plurality of propulsion devices through air. The embodiments of the present disclosure are not limited thereto, and the unmanned aerial vehicle may also be other types of unmanned aerial vehicles.

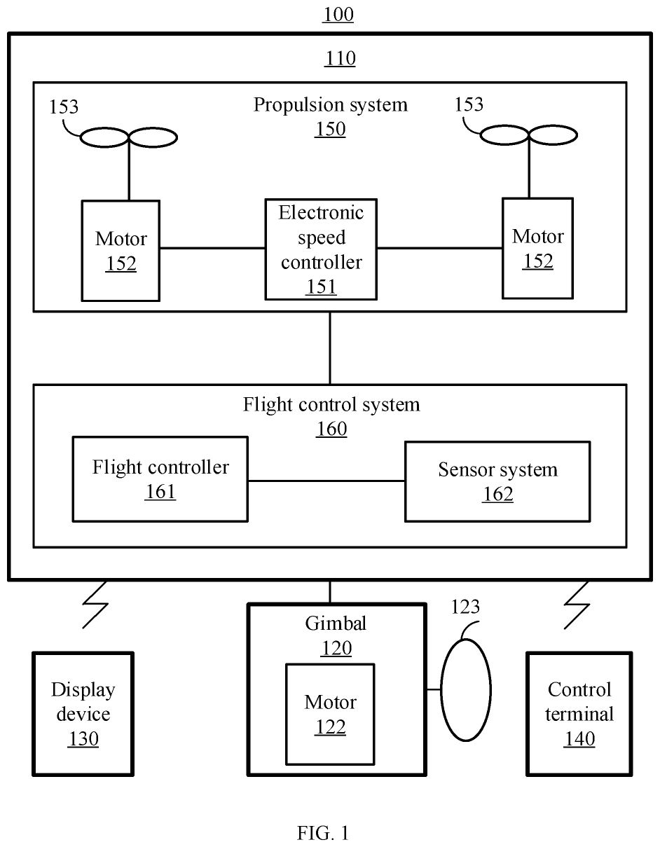

FIG. 1 is a schematic architecture diagram of an unmanned aerial system 100 according to the present disclosure. A rotor unmanned aerial vehicle is taken as an example for description of the present disclosure.

The unmanned aerial system 100 includes an unmanned aerial vehicle 110, a display device 130, and a control terminal 140. The unmanned aerial vehicle 110 includes a propulsion system 150, a flight control system 160, a frame, and a gimbal 120 carried at the frame. The unmanned aerial vehicle 110 can wirelessly communicate with the control terminal 140 and the display device 130.

The frame may include a vehicle body and a stand (also referred to as landing gear). The vehicle body may include a center frame and one or more arms connected to the center frame, and the one or more arms extend radially from the center frame. The stand is connected to the vehicle body, and is configured to support the unmanned aerial vehicle 110 when it is landed.

The propulsion system 150 includes one or more electronic speed controllers (referred to as ESC for short) 151, one or more propellers 153, and one or more motors 152 corresponding to the one or more propellers 153. The motor 152 is connected between the electronic speed controller 151 and the propeller 153, and the motor 152 and the propeller 153 are arranged at the arm of the unmanned aerial vehicle 110. The electronic speed controller 151 is configured to receive driving signals generated by the flight control system 160 and provide driving current to the motor 152 according to the driving signals to control the rotation speed of the motor 152. The motor 152 is configured to drive the propeller to rotate, so as to provide power for the flight of the unmanned aerial vehicle 110, and the power enables the unmanned aerial vehicle 110 to achieve one or more degrees of freedom of motion. In some embodiments, the unmanned aerial vehicle 110 may rotate about one or more rotation axes. For example, the rotation axis described above may include a roll axis (Roll), a yaw axis (Yaw), and a pitch axis (Pitch). The motor 152 may be a DC motor or an AC motor. Also, the motor 152 may be a brushless motor or a brush motor.

The flight control system 160 includes a flight controller 161 and a sensor system 162. The sensor system 162 is configured to measure attitude information of the unmanned aerial vehicle, i.e., position information and status information of the unmanned aerial vehicle 110 in space, such as three-dimensional position, three-dimensional angle, three-dimensional velocity, three-dimensional acceleration, and three-dimensional angular velocity, etc. The sensor system 162 may include, for example, at least one of sensors such as a gyroscope, an ultrasonic sensor, an electronic compass, an inertial measurement unit (IMU), a vision sensor, a global navigation satellite system, or a barometer. For example, the global navigation satellite system may be a Global Positioning System (GPS). The flight controller 161 is configured to control the flight of the unmanned aerial vehicle 110, for example, to control the flight of the unmanned aerial vehicle 110 according to the attitude information measured by the sensor system 162. The flight controller 161 can control the unmanned aerial vehicle 110 according to pre-programmed program instructions, and can also control the unmanned aerial vehicle 110 by responding to one or more control instructions from the control terminal 140.

The gimbal 120 includes a motor 122. The gimbal is configured to carry a photographing device 123. The flight controller 161 can control the movement of the gimbal 120 through the motor 122. As another embodiment, the gimbal 120 may further include a controller for controlling the movement of the gimbal 120 by controlling the motor 122. The gimbal 120 may be independent of the unmanned aerial vehicle 110 or a part of the unmanned aerial vehicle 110. The motor 122 may be a DC motor or an AC motor. Also, the motor 122 may be a brushless motor or a brush motor. It should also be understood that the gimbal can be located at the top of the unmanned aerial vehicle, or at the bottom of the unmanned aerial vehicle.

The photographing device 123 may be, for example, a device for capturing images, such as a camera or a video camera. The photographing device 123 may communicate with the flight controller, and take pictures under the control of the flight controller. The photographing device 123 of the present disclosure includes at least a photosensitive element, and the photosensitive element is, for example, a complementary metal oxide semiconductor (CMOS) sensor or a charge-coupled device (CCD) sensor. It can be understood that the photographing device 123 can also be directly fixed at the unmanned aerial vehicle 110 so that the gimbal 120 can be omitted.

The display device 130 is located at the ground end of the unmanned aerial system 100, which can communicate with the unmanned aerial vehicle 110 in a wireless manner, and is configured to display the attitude information of the unmanned aerial vehicle 110. In addition, an image captured by the photographing device may also be displayed on the display device 130. The display device 130 may be an independent device or integrated in the control terminal 140.

The control terminal 140 is located at the ground end of the unmanned aerial system 100, which can communicate with the unmanned aerial vehicle 110 in a wireless manner for remote control of the unmanned aerial vehicle 110.

Naming for each component of the unmanned aerial system described above is only for identification purpose, and is not to be construed as a limitation to the embodiments of the present disclosure.

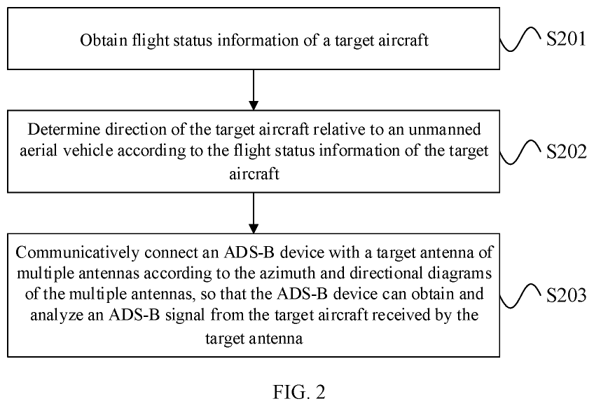

FIG. 2 is a flow chart of an unmanned aerial vehicle control method according to an embodiment of the present disclosure. The method can be applied to an unmanned aerial vehicle As shown in FIG. 2, the method includes the following processes.

S201, obtaining flight status information of a target aircraft. The flight status information of the target aircraft is obtained by analyzing an ADS-B signal from the target aircraft by an ADS-B device.

In the present disclosure, in order to ensure flight safety of the aircraft, the aircraft can send the ADS-B signal of the aircraft to outside, and the ADS-B signal carries the flight status information of the aircraft. The aircraft is provided with the ADS-B device, and the aircraft can broadcast the flight status information of the aircraft to outside through the ADS-B device.

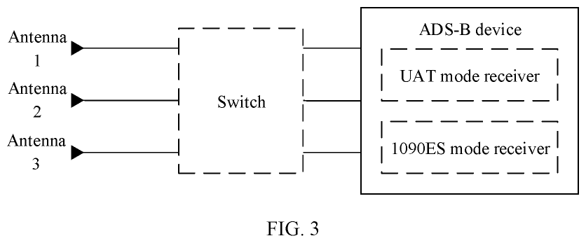

As shown in FIG. 3, the unmanned aerial vehicle of the present disclosure includes multiple antennas (such as antenna 1, antenna 2, and antenna 3, but is not limited thereto) and the ADS-B device, where the multiple antennas can receive the ADS-B signal from the aircraft.

When the target aircraft broadcasts the ADS-B signal to outside, the multiple antennas of the unmanned aerial vehicle can receive the ADS-B signal from the target aircraft, and the ADS-B device of the unmanned aerial vehicle analyzes and processes the ADS-B signal from the target aircraft to obtain the flight status information of the target aircraft, so that the unmanned aerial vehicle of the present disclosure can obtain the flight status information of the target aircraft.

In some embodiments, the flight status information of the target aircraft may include one or more of speed information, position information, heading information, acceleration information, altitude information, or identity information of the target aircraft.

S202, determining direction of the target aircraft relative to the unmanned aerial vehicle according to the flight status information of the target aircraft. This direction is also referred to as a “relative direction” of the target aircraft relative to the unmanned aerial vehicle.

In the present disclosure, after obtaining the flight status information of the target aircraft, the unmanned aerial vehicle determines the direction of the target aircraft relative to the unmanned aerial vehicle according to the flight status information of the target aircraft.

In some embodiments, before executing process S202, the unmanned aerial vehicle also obtains flight status information of the unmanned aerial vehicle. As for how to obtain the flight status information of the unmanned aerial vehicle, reference can be made to description of related technologies, which will not be repeated herein. Correspondingly, a possible implementation of process S202 may be determining the direction of the target aircraft relative to the unmanned aerial vehicle according to the flight status information of the target aircraft and the flight status information of the unmanned aerial vehicle.

In some embodiments, the flight status information of the unmanned aerial vehicle may include one or more of speed information, position information, heading information, acceleration information, altitude information, or identity information of the unmanned aerial vehicle.

S203, communicatively connecting the ADS-B device to a target antenna of the multiple antennas according to the relative direction and radiation patterns of the multiple antennas, so that the ADS-B device can obtain and analyze the ADS-B signal from the target aircraft received by the target antenna. The radiation patterns of the multiple antennas are different from each other.

In the present disclosure, each antenna has a corresponding radiation pattern, and directions of the multiple antennas are different from each other. After the direction of the target aircraft relative to the unmanned aerial vehicle is determined, the target antenna corresponding to the direction of the target aircraft relative to the unmanned aerial vehicle is determined from the multiple antennas according to the direction of the target aircraft relative to the unmanned aerial vehicle and the radiation patterns of the multiple antennas, and then the ADS-B device of the unmanned aerial vehicle is communicatively connected to the target antenna. Since the ADS-B device of the unmanned aerial vehicle is communicatively connected to the target antenna, the target antenna has better performance in receiving the ADS-B signal from the target aircraft, so that the ADS-B device of the unmanned aerial vehicle can obtain and analyze the flight status information of the target aircraft more accurately.

According to the unmanned aerial vehicle control method provided by the present disclosure, the flight status information of the target aircraft is obtained, and the flight status information of the target aircraft is obtained by analyzing the ADS-B signal from the target aircraft by the ADS-B device; the direction of the target aircraft relative to the unmanned aerial vehicle is determined according to the flight status information of the target aircraft; the ADS-B device is communicatively connected to a target antenna of the multiple antennas according to the relative direction and the radiation patterns of the multiple antennas, so that the ADS-B device can obtain and analyze the ADS-B signal from the target aircraft received by the target antenna; and the radiation patterns of the multiple antennas are different from each other. Since the target antenna has better performance in receiving the ADS-B signal from the target aircraft, so that the ADS-B device of the unmanned aerial vehicle can analyze and obtain the flight status information of the target aircraft more accurately, which reduces risk of collision between the unmanned aerial vehicle and the target aircraft.

In some embodiments, a possible implementation of communicatively connecting the ADS-B device to a target antenna of the multiple antennas in the process S203 is establishing a communication connection between the ADS-B device and a target antenna of the multiple antennas through a switch. In the present disclosure, the unmanned aerial vehicle is also provided with the switch. As shown in FIG. 3, the switch is connected to the ADS-B device, and is also connected to each of the multiple antennas. Therefore, in the present disclosure, the communication connection between the ADS-B device of the unmanned aerial vehicle and the target antenna can be established by controlling the switch.

In some embodiments, the ADS-B device includes receiver in an universal access transceiver (UAT) mode (also referred to as a UAT mode receiver) and/or a receiver in a mode S extended squitter transponder (1090ES) mode (also referred to as a 1090ES mode receiver). When the ADS-B device includes the UAT mode receiver, the ADS-B signal from the target aircraft includes an ADS-B signal based on a UAT protocol. When the ADS-B device includes the 1090ES mode receiver, the ADS-B signal from the target aircraft includes an ADS-B signal based on a 1090ES protocol.

In some embodiments, the ADS-B device includes the UAT mode receiver and the 1090ES mode receiver, and each of the multiple antennas is a dual-frequency antenna. That is, each antenna can receive the ADS-B signal based on the UAT protocol and the ADS-B signal based on the 1090ES protocol from the aircraft.

In some embodiments, the ADS-B device includes the UAT mode receiver, and the ADS-B signal from the target aircraft includes the ADS-B signal based on the UAT protocol. A possible implementation of communicatively connecting the ADS-B device to a target antenna of the multiple antennas in the process S203 is communicatively connecting the ADS-B device to a target antenna of the multiple antennas within a guard time interval of a signal frame of the ADS-B signal based on the UAT protocol.

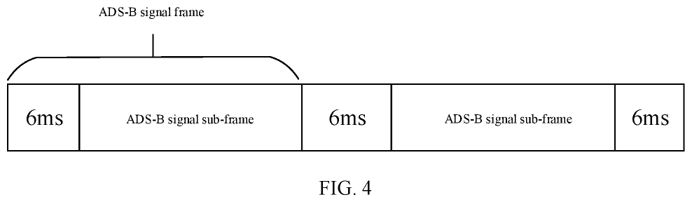

If the target antenna receives the ADS-B signal based on the UAT protocol from the target aircraft, the signal frame of the ADS-B signal based on the UAT protocol has the guard time interval. The unmanned aerial vehicle can communicatively connect the UAT mode receiver with a target antenna of the multiple antennas within the guard time interval without affecting normal reception of the signal frame of the ADS-B signal based on the UAT protocol, which avoids losing flight status parameters of the target aircraft. As shown in FIG. 4, the guard time interval is, for example, 6 ms of a frame header of the signal frame of the ADS-B signal based on the UAT protocol.

In some embodiments, the unmanned aerial vehicle also determines a collision coefficient between the target aircraft and the unmanned aerial vehicle according to the flight status information of the target aircraft. For example, the unmanned aerial vehicle can determine the collision coefficient between the target aircraft and the unmanned aerial vehicle according to the flight status information of the target aircraft and the flight status information of the unmanned aerial vehicle. The collision coefficient between the target aircraft and the unmanned aerial vehicle indicates degree of threat of the unmanned aerial vehicle to the target aircraft. For example, the higher the collision coefficient, the greater the degree of threat. Correspondingly, a possible implementation of the process S202 is, when the collision coefficient between the target aircraft and the unmanned aerial vehicle is greater than or equal to a first preset collision coefficient, determining the direction of the target aircraft relative to the unmanned aerial vehicle according to the flight status information of the target aircraft. In the present disclosure, the unmanned aerial vehicle determines whether the collision coefficient between the target aircraft and the unmanned aerial vehicle is less than the first preset collision coefficient. If the unmanned aerial vehicle determines that the collision coefficient between the target aircraft and the unmanned aerial vehicle is greater than or equal to the first preset collision coefficient, it indicates that the degree of threat of the unmanned aerial vehicle to the target aircraft is large, and the flight status information of the target aircraft needs to be accurately known to reduce the risk of collision between the unmanned aerial vehicle and the target aircraft, so the unmanned aerial vehicle executes the processes S202 and S203. If the unmanned aerial vehicle determines that the collision coefficient between the target aircraft and the unmanned aerial vehicle is less than the first preset collision coefficient, it indicates that the degree of threat of the unmanned aerial vehicle to the target aircraft is small, so the unmanned aerial vehicle does not need to execute the processes S202 and S203, but continues to execute process S201.

In some embodiments, a possible implementation of the process S203 may include: determining radiation gain of each antenna in a radiation direction corresponding to the relative direction according to the relative direction and the radiation patterns of the multiple antennas; communicatively connecting the ADS-B device to a target antenna of the multiple antennas according to the radiation gain of each of the multiple antennas in the radiation direction corresponding to the relative direction.

In the present disclosure, the radiation pattern of each of the multiple antennas can indicate the radiation gain of the antenna in different radiation directions. As shown in FIG. 3, the multiple antennas include antenna 1, antenna 2, and antenna 3, which may have different radiation gains in different radiation directions. After obtaining the direction of the target aircraft relative to the unmanned aerial vehicle, the unmanned aerial vehicle of the present disclosure determines the radiation gain of each antenna in the radiation direction corresponding to the relative direction according to the relative direction and the radiation patterns of the multiple antennas, determines a target antenna from the multiple antennas according to the radiation gain of each of the multiple antennas in the radiation direction corresponding to the relative direction, and then communicatively connects the ADS-B device of the unmanned aerial vehicle to the target antenna.

In some embodiments, a possible implementation of communicatively connecting the ADS-B device to a target antenna of the multiple antennas according to the radiation gain of each of the multiple antennas in the radiation direction corresponding to the relative direction is: determining a maximum radiation gain from the radiation gains of the multiple antennas in the radiation direction corresponding to the relative direction; and communicatively connecting the ADS-B device to an antenna corresponding to the maximum radiation gain among the multiple antennas.

In the present disclosure, after the radiation gain of each antenna in the radiation direction corresponding to the relative direction is determined according to the relative direction and the radiation patterns of the multiple antennas, the maximum radiation gain is determined from the radiation gains of the multiple antennas in the radiation direction corresponding to the relative direction, the antenna corresponding to the maximum radiation gain is determined as the target antenna, and then the ADS-B device is communicatively connected to the target antenna. Since the radiation gain corresponding to the target antenna is the largest in the radiation direction corresponding to the relative direction, the target antenna has the best performance in receiving the ADS-B signal from the target aircraft, so that the ADS-B device of the unmanned aerial vehicle can obtain and analyze the flight status information of the target aircraft more accurately after connecting to the target antenna.

In some embodiments, another possible implementation of communicatively connecting the ADS-B device to a target antenna of the multiple antennas according to the radiation gain of each of the multiple antennas in the radiation direction corresponding to the relative direction is: determining a duration configuration parameter of the communication connection between the ADS-B device and each antenna according to the radiation gain of each antenna in the radiation direction corresponding to the relative direction; and communicatively connecting the ADS-B device to each of the multiple antennas in turn according to the duration configuration parameters of the communication connection between the ADS-B device and various antennas.

In the present disclosure, after the radiation gain of each antenna in the radiation direction corresponding to the relative direction is determined according to the relative direction and the radiation patterns of the multiple antennas, for each of the multiple antennas, the duration configuration parameter of the communication connection between the ADS-B device of the unmanned aerial vehicle and the antenna is determined according to the radiation gain of the antenna in the radiation direction corresponding to the relative direction, and then the ADS-B device of the unmanned aerial vehicle is communicatively connected to each of the multiple antennas in turn according to the duration configuration parameters of the communication connection between the ADS-B device of the unmanned aerial vehicle and the various antennas, so that it is ensured that the ADS-B device of the unmanned aerial vehicle can analyze the flight status information from various aircraft received by each antenna, which reduces the risk of collision between the unmanned aerial vehicle and other aircraft.

In some embodiments, the radiation gain of the antenna in the radiation direction corresponding to the relative direction is positively correlated with the duration configuration parameter of the communication connection between the ADS-B device and the antenna.

In some embodiments, the duration configuration parameter includes duration or duration ratio.

The larger the radiation gain of the antenna in the radiation direction corresponding to the relative direction, the larger the duration or the duration ratio of the communication connection between the ADS-B device of the unmanned aerial vehicle and the antenna, which can ensure that the ADS-B device of the unmanned aerial vehicle can obtain and analyze the flight status information of the target aircraft as accurately as possible.

For example, the multiple antennas include antenna 1, antenna 2, and antenna 3. If it is determined that durations of communication connection between the ADS-B device of the unmanned aerial vehicle and the antenna 1, the antenna 2, and the antenna 3 are 3 seconds, 2 seconds, and 1 second, respectively, according to radiation gains of antenna 1, antenna 2, and antenna 3 in the radiation direction corresponding to the relative direction, respectively, then the ADS-B device of the unmanned aerial vehicle is first communicatively connected to the antenna 1 for 3 seconds, then the ADS-B device of the unmanned aerial vehicle is communicatively connected to the antenna 2 for 2 seconds, then the ADS-B device of the unmanned aerial vehicle is communicatively connected to the antenna 3 for 1 second, and afterwards, in some embodiments, the ADS-B device of the unmanned aerial vehicle can be communicatively connected to the antenna 1 again, which is similar to the above process and will not be repeated herein.

In some embodiments, the unmanned aerial vehicle also determines the collision coefficient between the target aircraft and the unmanned aerial vehicle according to the flight status information of the target aircraft. Correspondingly, a possible implementation of determining the duration configuration parameter of the communication connection between the ADS-B device and each antenna according to the radiation gain of each antenna in the radiation direction corresponding to the relative direction is, when the collision coefficient between the target aircraft and the unmanned aerial vehicle is greater than or equal to a second preset collision coefficient, determining the duration configuration parameter of the communication connection between the ADS-B device and each antenna according to the radiation gain of each antenna in the radiation direction corresponding to the relative direction. That is, after determining the collision coefficient between the target aircraft and the unmanned aerial vehicle, the unmanned aerial vehicle determines whether the collision coefficient between the target aircraft and the unmanned aerial vehicle is less than the second preset collision coefficient. If the collision coefficient between the target aircraft and the unmanned aerial vehicle is greater than or equal to the second preset collision coefficient, it indicates that the degree of threat of the unmanned aerial vehicle to the target aircraft is large, and the ADS-B equipment of the unmanned aerial vehicle needs to analyze and obtain the flight status information of the target aircraft as accurately as possible, and the unmanned aerial vehicle determines the duration configuration parameter of the communication connection between the ADS-B device and each antenna according to the radiation gain of each antenna in the radiation direction corresponding to the relative direction, so as to ensure that the target antenna receives the ADS-B signal from the target aircraft as long as possible. In some embodiments, if the collision coefficient between the target aircraft and the unmanned aerial vehicle is less than the second preset collision coefficient, it indicates that that the degree of threat of the unmanned aerial vehicle to the target aircraft is small, and the unmanned aerial vehicle determines that the duration configuration parameters of the communication connection between the ADS-B device with the various antennas are a same preset duration configuration parameter. For example, the durations of the communication connection between the ADS-B device of the unmanned aerial vehicle with the various antennas in turn are the same, so that the various antennas can receive the ADS-B signals from the various aircraft equally in all directions.

In some embodiments, a possible implementation of the process S201 is obtaining flight status information of multiple aircrafts, where the status information of the multiple aircrafts includes the status information of the target aircraft. If there are multiple aircrafts broadcasting the ADS-B signals to outside, correspondingly, the unmanned aerial vehicle receives the ADS-B signals from the multiple aircrafts through multiple antennas, and then the ADS-B device of the unmanned aerial vehicle separately analyzes the ADS-B signals from the multiple aircrafts to obtain the flight status information of the multiple aircrafts, where the multiple aircrafts include the target aircraft. Correspondingly, the unmanned aerial vehicle also determines the collision coefficient between each aircraft and the unmanned aerial vehicle according to the flight status information of the multiple aircrafts. For example, the unmanned aerial vehicle can determine the collision coefficient between each aircraft and the unmanned aerial vehicle according to the flight status information of each of the multiple aircrafts and the flight status information of the unmanned aerial vehicle. Then the unmanned aerial vehicle determines one or more of the target aircraft from the multiple aircrafts according to the collision coefficient between each of the multiple aircrafts and the unmanned aerial vehicle. The collision coefficient between the aircraft and the unmanned aerial vehicle indicates the degree of threat of the unmanned aerial vehicle to the aircraft, for example, the higher the collision coefficient, the greater the degree of threat.

In some embodiments, a possible implementation of determining one or more target aircrafts from the multiple aircrafts according to the collision coefficient is: determining a maximum collision coefficient from the collision coefficients between the multiple aircrafts and the unmanned aerial vehicle; determining the aircraft corresponding to the maximum collision coefficient among the multiple aircrafts as the target aircraft. That is, after obtaining the collision coefficient between each of the multiple aircrafts and the unmanned aerial vehicle, the unmanned aerial vehicle determines the maximum collision coefficient from the collision coefficients, and determines the aircraft corresponding to the maximum collision coefficient as the target aircraft, where there may be one or more target aircrafts corresponding to the maximum collision coefficient. As such, it is ensured that the unmanned aerial vehicle receives the ADS-B signal of the aircraft with a maximum risk of collision with the unmanned aerial vehicle as accurately as possible.

In some embodiments, a possible implementation of determining one or more target aircrafts from the multiple aircrafts according to the collision coefficient is: determining a collision coefficient greater than or equal to a third preset collision coefficient from the collision coefficients between the multiple aircrafts and the unmanned aerial vehicle; determining the aircraft corresponding to the collision coefficient greater than or equal to the third preset collision coefficient among the multiple aircrafts as the target aircraft. That is, after obtaining the collision coefficient between each of the multiple aircrafts and the unmanned aerial vehicle, the unmanned aerial vehicle determines at least one collision coefficient greater than or equal to the third preset collision coefficient from the collision coefficients, and determines the aircraft corresponding to the determined at least one collision coefficient as the target aircraft. If there is one determined collision coefficient, then there is one or more target aircraft; if there are multiple determined collision coefficients, then there are multiple target aircrafts.

In some embodiments, a possible implementation of determining one or more target aircrafts from the multiple aircrafts according to the collision coefficient is: determining a maximum collision coefficient greater than or equal to the third preset collision coefficient from the collision coefficients between the multiple aircrafts and the unmanned aerial vehicle; determining the aircraft corresponding to the maximum collision coefficient greater than or equal to the third preset collision coefficient among the multiple aircrafts as the target aircraft. The present disclosure does not limit the order of determining the collision coefficient greater than or equal to the third preset collision coefficient and determining the maximum collision coefficient.

In some embodiments, if it is determined that the number of collision coefficients greater than or equal to the third preset collision coefficient from the collision coefficients between the multiple aircrafts and the unmanned aerial vehicle is 0, it indicates that no target aircraft is determined from the multiple aircrafts.

If there are multiple target aircrafts, the relative direction of each of the multiple target aircrafts relative to the unmanned aerial vehicle can be determined in the process S202.

If there are multiple target aircrafts, when executing the process S203, the unmanned aerial vehicle can determine multiple target antennas according to the relative direction of each of the multiple target aircrafts relative to the unmanned aerial vehicle and the radiation patterns of the multiple antennas, and then communicatively connect the ADS-B device to each of the multiple target antennas, so that the ADS-B device can obtain and analyze the ADS-B signals from the target aircraft received by the corresponding target antennas in turn, which reduces the risk of collision between the unmanned aerial vehicle and the multiple target aircrafts.

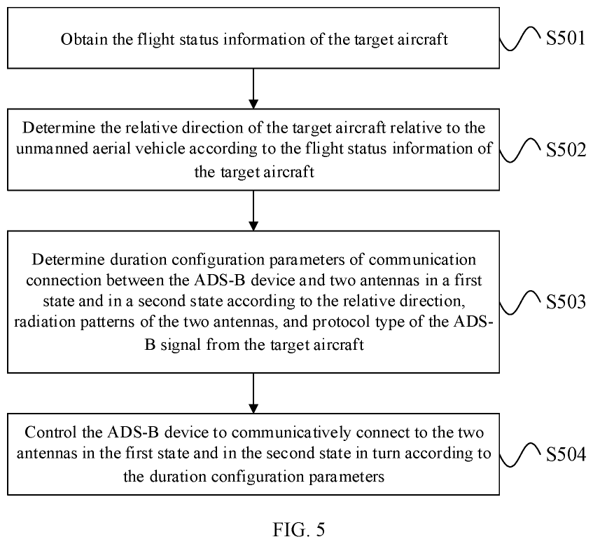

FIG. 5 is a flow chart of the unmanned aerial vehicle control method according to another embodiment of the present disclosure. As shown in FIG. 5, the method of the present disclosure includes the following processes.

S501, obtaining the flight status information of the target aircraft. The flight status information of the target aircraft is obtained by analyzing the ADS-B signal from the target aircraft by the ADS-B device.

In the present disclosure, in order to ensure the flight safety of the aircraft, the aircraft can send the ADS-B signal of the aircraft to outside, and the ADS-B signal carries the flight status information of the aircraft. The aircraft is provided with the ADS-B device, and the aircraft can broadcast the flight status information of the aircraft to outside through the ADS-B device.

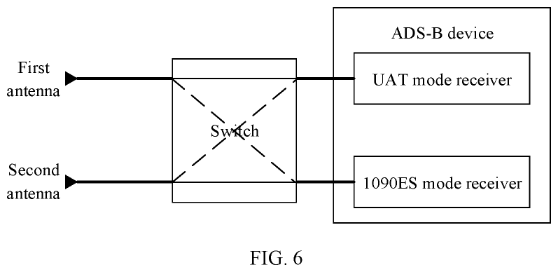

As shown in FIG. 6, the unmanned aerial vehicle of the present disclosure is provided with two antennas (for example, a first antenna and a second antenna) with different radiation patterns and the ADS-B device. The two antennas are configured to receive the ADS-B signal from the aircraft, and each antenna is the dual-frequency antenna that can receive the ADS-B signal based on the UAT protocol and the ADS-B signal based on the 1090ES protocol. The ADS-B device includes the UAT mode receiver configured to analyze the ADS-B signal based on the UAT protocol and the 1090ES mode receiver configured to analyze the ADS-B signal based on the 1090ES protocol.

When the target aircraft broadcasts the ADS-B signal to outside, the two antennas of the unmanned aerial vehicle can receive the ADS-B signal from the target aircraft, and the ADS-B device of the unmanned aerial vehicle analyzes and processes the ADS-B signal from the target aircraft to obtain the flight status information of the target aircraft, so that the unmanned aerial vehicle of the present disclosure can obtain the flight status information of the target aircraft.

S502, determining the direction of the target aircraft relative to the unmanned aerial vehicle according to the flight status information of the target aircraft.

In the present disclosure, for process S502, reference can be made to the description of the process S202, which will not be repeated herein.

S503, determining duration configuration parameters of the communication connections between the ADS-B device and the two antennas in a first state and in a second state according to the relative direction, the radiation patterns of the two antennas, and protocol type of the ADS-B signal from the target aircraft.

In the present disclosure, after the direction of the target aircraft relative to the unmanned aerial vehicle is obtained, the duration configuration parameter of the communication connection between the ADS-B device and the two antennas in the first state and the duration configuration parameter of the communication connection between the ADS-B device and the two antennas in the second state are determined according to the relative direction, the radiation patterns of the two antennas, and the protocol type of the ADS-B signal from the target aircraft. The ADS-B device is connected to the two antennas at the same time. The first state is that the UAT mode receiver is communicatively connected to the first antenna, and the 1090ES mode receiver is communicatively connected to the second antenna, as shown by solid lines in FIG. 6; the second state is that the UAT mode receiver is communicatively connected to the second antenna, and the 1090ES mode receiver is communicatively connected to the first antenna, as shown by dashed lines in FIG. 6.

S504, controlling the ADS-B device to communicatively connect to the two antennas in the first state and in the second state in turn according to the duration configuration parameters.

In the present disclosure, the unmanned aerial vehicle controls the ADS-B device to communicatively connect to the two antennas in the first state and in the second state in turn according to the duration configuration parameter of the communication connection between the ADS-B device of the unmanned aerial vehicle and the two antennas in the first state and the duration configuration parameter of the communication connection between the ADS-B device of the unmanned aerial vehicle and the two antennas in the second state.

In some embodiments, the duration configuration parameter includes the duration or the duration ratio. For example, if the duration of the communication connection between the ADS-B device of the unmanned aerial vehicle and the two antennas in the first state is 2 seconds, and the duration of the communication connection between the ADS-B device of the unmanned aerial vehicle and the two antennas in the second state is 1 second, then the unmanned aerial vehicle controls the UAT mode receiver to communicatively connect to the first antenna, and controls the 1090ES mode receiver to communicatively connect the second antenna. After the above communication connection is maintained for 2 seconds, the unmanned aerial vehicle controls the UAT mode receiver to communicatively connect to the second antenna, and controls the 1090ES mode receiver to communicatively connect to the first antenna. After the above communication connection is maintained for 1 second, in some embodiments, the unmanned aerial vehicle controls the UAT mode receiver to communicatively connect to the first antenna, and controls the 1090ES mode receiver to communicatively connect to the second antenna, and so on, which will not be repeated herein.

According to the above scheme in the unmanned aerial vehicle control method provided by the present disclosure, the duration configuration parameters of the communication connection between the ADS-B device of the unmanned aerial vehicle and the two antennas in the first state and in the second state can be determined according to the direction of the target aircraft relative to the unmanned aerial vehicle, the radiation patterns of the two antennas, and the protocol type of the ADS-B signal from the target aircraft. The duration configuration parameters of the communication connection between the ADS-B device and the two antennas in the first state and in the second state may be different, which causes the ADS-B device to be connected to the two antennas in different states in turn according to different duration configuration parameters, so that the UAT mode receiver or the 1090ES mode receiver with the same protocol type as the ADS-B signal from the target aircraft can more accurately analyze and obtain the flight status information of the target aircraft, which reduces the risk of collision between the target aircraft and the unmanned aerial vehicle.

In some embodiments, a possible implementation of controlling the ADS-B device to communicatively connect to the two antennas in the first state and in the second state in turn in the process S504 is controlling the ADS-B device to communicatively connect to the two antennas in the first state and in the second state in turn through the switch. In some embodiments, the unmanned aerial vehicle is also provided with the switch. As shown in FIG. 6, the switch is connected to the UAT mode receiver and the 1090ES mode receiver, and is also connected to the first antenna and the second antenna. Therefore, in the present disclosure, the communication connection between the UAT mode receiver of the unmanned aerial vehicle and the first antenna and the communication connection between the 1090ES mode receiver and the second antenna can be established by controlling the switch. The communication connection between the UAT mode receiver of the unmanned aerial vehicle and the second antenna and the communication connection between the 1090ES mode receiver and the first antenna can also be established by controlling the switch.

In some embodiments, the ADS-B signal from the target aircraft includes the ADS-B signal based on the UAT protocol, and a possible implementation of controlling the ADS-B device to communicatively connect to the two antennas in the first state and in the second state in turn in the process S504 is: controlling the ADS-B device to communicatively connect to the two antennas in the first state and in the second state in turn within the guard time interval of the signal frame of the ADS-B signal based on the UAT protocol.

The signal frame of the ADS-B signal based on the UAT protocol has the guard time interval. The UAT mode receiver can be communicatively connected to a target antenna of the multiple antennas within the guard time interval without affecting the normal reception of the signal frame of the ADS-B signal based on the UAT protocol, which avoids losing the flight status parameters of the target aircraft. As shown in FIG. 4, the guard time interval is, for example, 6 ms of the frame header of the signal frame of the ADS-B signal based on the UAT protocol. Therefore, the unmanned aerial vehicle of the present disclosure controls the ADS-B device to switch between the first state and the second state within 6 ms of the frame header of the signal frame of the ADS-B signal based on the UAT protocol to communicatively connect to the two antennas.

In some embodiments, the unmanned aerial vehicle also determines the collision coefficient between the target aircraft and the unmanned aerial vehicle according to the flight status information of the target aircraft. Correspondingly, a possible implementation of the process S503 is, when the collision coefficient between the target aircraft and the unmanned aerial vehicle is greater than or equal to a fourth preset collision coefficient, determining the duration configuration parameters of the communication connection between the ADS-B device and the two antennas in the first state and in the second state according to the relative direction, the radiation patterns of the two antennas, and the protocol type of the ADS-B signal from the target aircraft.

In the present disclosure, the unmanned aerial vehicle determines whether the collision coefficient between the target aircraft and the unmanned aerial vehicle is less than the fourth preset collision coefficient. If the unmanned aerial vehicle determines that the collision coefficient between the target aircraft and the unmanned aerial vehicle is greater than or equal to the fourth preset collision coefficient, it indicates that the degree of threat of the unmanned aerial vehicle to the target aircraft is large, and the flight status information of the target aircraft needs to be accurately known to reduce the risk of collision between the unmanned aerial vehicle and the target aircraft, so the unmanned aerial vehicle executes the processes S503 and S504 to ensure that one of the two antennas receives the ADS-B signal from the target aircraft as long as possible.

In some embodiments, if the unmanned aerial vehicle determines that the collision coefficient between the target aircraft and the unmanned aerial vehicle is less than the fourth preset collision coefficient, it indicates that the degree of threat of the unmanned aerial vehicle to the target aircraft is small, so the unmanned aerial vehicle determines that the duration configuration parameters of the communication connection between the ADS-B device and the two antennas in the first state and in the second state are the same duration configuration parameter. For example, the UAT mode receiver is communicatively connected to the first antenna and the second antenna in turn for the same duration, and the 1090ES mode receiver is communicatively connected to the first antenna and the second antenna in turn for the same duration, so that the various antennas can receive the ADS-B signals from the various aircraft equally in all directions.

In some embodiments, a possible implementation of the process S503 is: determining the radiation gain of each antenna in the radiation direction corresponding to the relative direction according to the relative direction and the radiation patterns of the two antennas; and determining the duration configuration parameters of the communication connection between the ADS-B device and the two antennas in the first state and in the second state according to the radiation gain of each of the two antennas in the radiation direction corresponding to the relative direction and the protocol type of the ADS-B signal from the target aircraft.

In the present disclosure, the radiation pattern of the first antenna is different from that of the second antenna, and the radiation gains of the first antenna in different radiation directions may be different. After obtaining the direction of the target aircraft relative to the unmanned aerial vehicle, the unmanned aerial vehicle of the present disclosure determines the radiation gain of the first antenna in the radiation direction corresponding to the relative direction according to the relative direction and the radiation pattern of the first antenna, determines the radiation gain of the second antenna in the radiation direction corresponding to the relative direction according to the relative direction and the radiation pattern of the second antenna, and then determines the duration configuration parameters of the communication connection between the ADS-B device and the two antennas in the first state and in the second state according to the radiation gain of the first antenna in the radiation direction corresponding to the relative direction, the radiation gain of the second antenna in the radiation direction corresponding to the relative direction, and the protocol type of the ADS-B signal from the target aircraft.

In some embodiments, duration configuration parameter of the communication connection between the ADS-B device and the two antennas in a target state of the first state and the second state is greater than duration configuration parameter of the communication connection between the ADS-B device and the two antennas in the other state of the first state and the second state. The target state is that a target receiver of the UAT mode receiver and the 1090ES mode receiver is communicatively connected to a target antenna of the two antennas, and the other receiver of the UAT mode receiver and the 1090ES mode receiver is communicatively connected to the other antenna of the two antennas. The target receiver is one of the UAT mode receiver and the 1090ES mode receiver that matches a protocol of the ADS-B signal from the target aircraft, and the target antenna is one of the two antennas with the maximum radiation gain in the radiation direction corresponding to the relative direction.

That is, if the protocol of the ADS-B signal from the target aircraft is the UAT protocol, then it is determined that the target receiver is the UAT mode receiver according to the UAT protocol. If it is determined that the radiation gain of the first antenna in the radiation direction corresponding to the relative direction is greater than the radiation gain of the second antenna in the radiation direction corresponding to the relative direction according to the radiation gain of the first antenna in the radiation direction corresponding to the relative direction and the radiation gain of the second antenna in the radiation direction corresponding to the relative direction, then it is determined that the target antenna is the first antenna, the target state is the first state, and the duration configuration parameter of the communication connection between the ADS-B device and the two antennas according to the first state is greater than the duration configuration parameter of the communication connection between the ADS-B device and the two antennas according to the second state. If it is determined that the radiation gain of the first antenna in the radiation direction corresponding to the relative direction is less than the radiation gain of the second antenna in the radiation direction corresponding to the relative direction according to the radiation gain of the first antenna in the radiation direction corresponding to the relative direction and the radiation gain of the second antenna in the radiation direction corresponding to the relative direction, then it is determined that the target antenna is the second antenna, the target state is the second state, and the duration configuration parameter of the communication connection between the ADS-B device and the two antennas according to the second state is greater than the duration configuration parameter of the communication connection between the ADS-B device and the two antennas according to the first state.

If the protocol of the ADS-B signal from the target aircraft is the 1090ES protocol, then it is determined that the target receiver is the 1090ES mode receiver according to the 1090ES protocol. If it is determined that the radiation gain of the first antenna in the radiation direction corresponding to the relative direction is greater than the radiation gain of the second antenna in the radiation direction corresponding to the relative direction according to the radiation gain of the first antenna in the radiation direction corresponding to the relative direction and the radiation gain of the second antenna in the radiation direction corresponding to the relative direction, then it is determined that the target antenna is the first antenna, the target state is the second state, and the duration configuration parameter of the communication connection between the ADS-B device and the two antennas according to the second state is greater than the duration configuration parameter of the communication connection between the ADS-B device and the two antennas according to the first state. If it is determined that the radiation gain of the first antenna in the radiation direction corresponding to the relative direction is less than the radiation gain of the second antenna in the radiation direction corresponding to the relative direction according to the radiation gain of the first antenna in the radiation direction corresponding to the relative direction and the radiation gain of the second antenna in the radiation direction corresponding to the relative direction, then it is determined that the target antenna is the second antenna, the target state is the first state, and the duration configuration parameter of the communication connection between the ADS-B device and the two antennas according to the first state is greater than the duration configuration parameter of the communication connection between the ADS-B device and the two antennas according to the second state.

In some embodiments, a possible implementation of the process S501 is obtaining the flight status information of the multiple aircrafts, where the status information of the multiple aircrafts includes the status information of the target aircraft. Correspondingly, the unmanned aerial vehicle determines the collision coefficient between each aircraft and the unmanned aerial vehicle according to the flight status information of the multiple aircrafts, and determines one or more target aircrafts from the multiple aircrafts according to the collision coefficient. For specific implementation process, reference may be made to similar description in related embodiments of FIG. 2, which will not be repeated herein.

In some embodiments, a possible implementation of determining one or more target aircrafts from the multiple aircrafts according to the collision coefficient includes: determining the maximum collision coefficient from the collision coefficients between the multiple aircrafts and the unmanned aerial vehicle; determining the aircraft corresponding to the maximum collision coefficient among the multiple aircrafts as the target aircraft. For specific implementation process, reference may be made to similar description in related embodiments of FIG. 2, which will not be repeated herein.

The present disclosure also provides a computer storage medium. The computer storage medium stores program instructions, and the program, when executed, may include some or all of the processes of the unmanned aerial vehicle control method of FIG. 2 or FIG. 5 and the corresponding embodiments thereof.

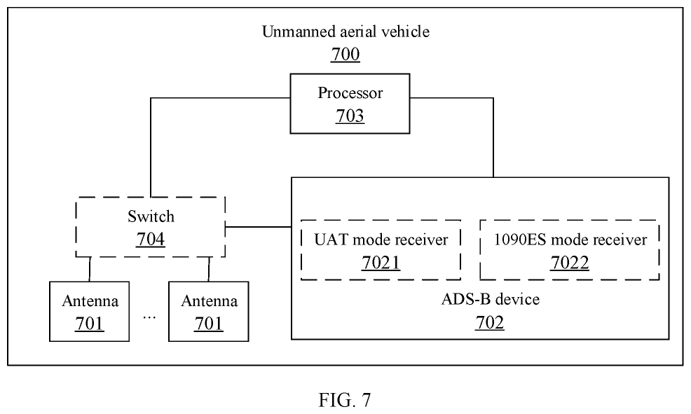

FIG. 7 is a schematic structural diagram of the unmanned aerial vehicle according to an embodiment of the present disclosure. As shown in FIG. 7, an unmanned aerial vehicle 700 of the present disclosure is provided with multiple antennas 701, an ADS-B device 702, and a processor 703.

The multiple antennas 701 are configured to receive the ADS-B signal from the aircraft.

The ADS-B device 702 is configured to analyze the ADS-B signal from the target aircraft to obtain the flight status information of the target aircraft.

The processor 703 is configured to obtain the flight status information of the target aircraft; determine the direction of the target aircraft relative to the unmanned aerial vehicle 700 according to the flight status information of the target aircraft; and communicatively connect the ADS-B device 702 with a target antenna of the multiple antennas 701 according to the relative direction and radiation patterns of the multiple antennas 701, so that the ADS-B device 702 can obtain and analyze the ADS-B signal from the target aircraft received by the target antenna. The radiation patterns of the multiple antennas are different from each other.

In some embodiments, the processor 703 is specifically configured to: determine the radiation gain of each antenna 701 in the radiation direction corresponding to the relative direction according to the relative direction and the radiation patterns of the multiple antennas 701; and communicatively connect the ADS-B device 702 with a target antenna of the multiple antennas 701 according to the radiation gain of each of the multiple antennas 701 in the radiation direction corresponding to the relative direction.

In some embodiments, the processor 703 is specifically configured to: determine the maximum radiation gain from the radiation gains of the multiple antennas 701 in the radiation direction corresponding to the relative direction; and communicatively connect the ADS-B device 702 with an antenna corresponding to the maximum radiation gain among the multiple antennas 701.

In some embodiments, the processor 703 is specifically configured to: determine the duration configuration parameter of the communication connection between the ADS-B device 702 and each antenna 701 according to the radiation gain of each antenna 701 in the radiation direction corresponding to the relative direction; and communicatively connect the ADS-B device 702 with each of the multiple antennas 701 in turn according to the duration configuration parameters of the communication connection between the ADS-B device 702 and various antennas 701.

In some embodiments, the radiation gain of the antenna 701 in the radiation direction corresponding to the relative direction is positively correlated with the duration configuration parameter of the communication connection between the ADS-B device and the antenna.

In some embodiments, the duration configuration parameter includes the duration or the duration ratio.

In some embodiments, when obtaining the flight status information of the target aircraft, the processor 703 is specifically configured to obtain the flight status information of multiple aircrafts, where the status information of the multiple aircrafts includes the status information of the target aircraft.

The processor 703 is also configured to: determine the collision coefficient between each aircraft and the unmanned aerial vehicle 700 according to the flight status information of the multiple aircraft; and determine one or more target aircrafts from the multiple aircrafts according to the collision coefficient.

In some embodiments, the processor 703 is specifically configured to: determine the maximum collision coefficient from the collision coefficients between the multiple aircrafts and the unmanned aerial vehicle 700; and determine the aircraft corresponding to the maximum collision coefficient among the multiple aircrafts as the target aircraft.

In some embodiments, the processor 703 is also configured to determine the collision coefficient between the target aircraft and the unmanned aerial vehicle 700 according to the flight status information of the target aircraft.

When determining the direction of the target aircraft relative to the unmanned aerial vehicle 700 according to the flight status information of the target aircraft, the processor 703 is specifically configured to, when the collision coefficient between the target aircraft and the unmanned aerial vehicle 700 is greater than or equal to the first preset collision coefficient, determine the direction of the target aircraft relative to the unmanned aerial vehicle 700 according to the flight status information of the target aircraft.

In some embodiments, the processor 703 is also configured to determine the collision coefficient between the target aircraft and the unmanned aerial vehicle 700 according to the flight status information of the target aircraft.

When determining the duration configuration parameter of the communication connection between the ADS-B device 702 and each antenna 701 according to the radiation gain of each antenna 701 in the radiation direction corresponding to the relative direction, the processor 703 is specifically configured to, when the collision coefficient between the target aircraft and the unmanned aerial vehicle is greater than or equal to the second preset collision coefficient, determine the duration configuration parameter of the communication connection between the ADS-B device 702 and each antenna 701 according to the radiation gain of each antenna 701 in the radiation direction corresponding to the relative direction.

In some embodiments, the processor 703 is also configured to, when the collision coefficient between the target aircraft and the unmanned aerial vehicle 700 is less than the second preset collision coefficient, determine that the duration configuration parameters of the communication connection between the ADS-B device 702 with the various antennas 701 are the same preset duration configuration parameter.

In some embodiments, the unmanned aerial vehicle 700 also includes a switch 704.

The processor 703 is specifically configured to establish the communication connection between the ADS-B device 702 and a target antenna of the multiple antennas 701 through the switch 704.

In some embodiments, the ADS-B device 702 includes a UAT mode receiver 7021 and/or a 1090ES mode receiver 7022.

In some embodiments, the ADS-B device 702 includes the UAT mode receiver 7021 and the 1090ES mode receiver 7022, and each of the multiple antennas 701 is the dual-frequency antenna.

In some embodiments, the ADS-B device 702 includes the UAT mode receiver 7021, and the ADS-B signal from the target aircraft includes the ADS-B signal based on the UAT protocol.

The processor 703 is specifically configured to communicatively connect the ADS-B device to a target antenna of the multiple antennas within the guard time interval of the signal frame of the ADS-B signal based on the UAT protocol.

The unmanned aerial vehicle of the present disclosure can be used to implement the technical solutions of FIG. 2 and the corresponding method thereof, and the implementation principle and technical effect thereof are similar, which will not be repeated herein.

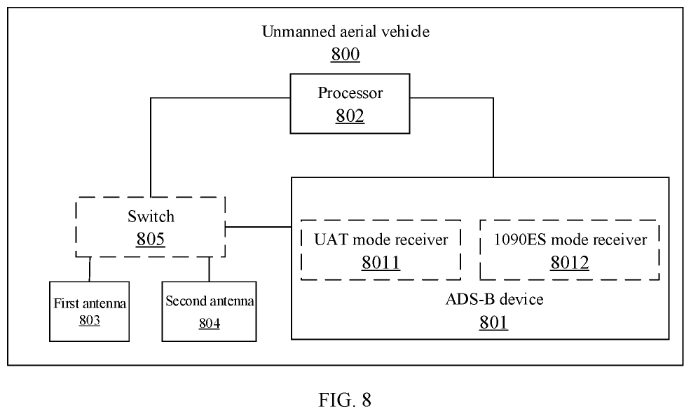

FIG. 8 is a schematic structural diagram of the unmanned aerial vehicle according to another embodiment of the present disclosure. As shown in FIG. 8, an unmanned aerial vehicle 800 of the present disclosure is provided with an ADS-B device 801, a processor 802, and two antennas with different radiation patterns. The two antennas include a first antenna 803 and a second antenna 804. The ADS-B device 801 includes a UAT mode receiver 8011 configured to analyze the ADS-B signal based on the UAT protocol and a 1090ES mode receiver 8012 configured to analyze the ADS-B signal based on the 1090ES protocol.

The two antennas are configured to receive the ADS-B signal from the aircraft, and each antenna is the dual-frequency antenna.

The ADS-B device 801 is configured to analyze the ADS-B signal from the target aircraft to obtain the flight status information of the target aircraft.

The process 802 is configured to obtain the flight status information of the target aircraft; determine the direction of the target aircraft relative to the unmanned aerial vehicle 800 according to the flight status information of the target aircraft; determine the duration configuration parameters of the communication connection between the ADS-B device 801 and the two antennas in the first state and in the second state according to the relative direction, the radiation patterns of the two antennas, and the protocol type of the ADS-B signal from the target aircraft; and control the ADS-B device 801 to communicatively connect to the two antennas in the first state and in the second state in turn according to the duration configuration parameters.

The first state is that the UAT mode receiver 8011 is communicatively connected to the first antenna 803, and the 1090ES mode receiver 8012 is communicatively connected to the second antenna 804.

The second state is that the UAT mode receiver 8011 is communicatively connected to the second antenna 804, and the 1090ES mode receiver 8012 is communicatively connected to the first antenna 803.

In some embodiments, the processor 802 is specifically configured to: determine the radiation gain of each antenna in the radiation direction corresponding to the relative direction according to the relative direction and the radiation patterns of the two antennas; and determine the duration configuration parameters of the communication connection between the ADS-B device 801 and the two antennas in the first state and in the second state according to the radiation gain of each of the two antennas in the radiation direction corresponding to the relative direction and the protocol type of the ADS-B signal from the target aircraft.

In some embodiments, the duration configuration parameter of the communication connection between the ADS-B device and the two antennas in the target state of the first state and the second state is greater than the duration configuration parameter of the communication connection between the ADS-B device and the two antennas in the other state of the first state and the second state.

The target state is that a target receiver of the UAT mode receiver 8011 and the 1090ES mode receiver 8012 is communicatively connected to a target antenna of the two antennas, and the other receiver of the UAT mode receiver 8011 and the 1090ES mode receiver 8012 is communicatively connected to the other antenna of the two antennas.

The target receiver is one of the UAT mode receiver 8011 and the 1090ES mode receiver 8012 that matches the protocol of the ADS-B signal from the target aircraft, and the target antenna is one of the two antennas with the maximum radiation gain in the radiation direction corresponding to the relative direction.

In some embodiments, the duration configuration parameter includes the duration or the duration ratio.

In some embodiments, when obtaining the flight status information of the target aircraft, the processor 802 is specifically configured to obtain the flight status information of multiple aircrafts, where the status information of the multiple aircrafts includes the status information of the target aircraft.

The processor 802 is also configured to: determine the collision coefficient between each aircraft and the unmanned aerial vehicle 800 according to the flight status information of the multiple aircraft; and determine one or more target aircrafts from the multiple aircrafts according to the collision coefficient.

In some embodiments, the processor 802 is specifically configured to: determine the maximum collision coefficient from the collision coefficients between the multiple aircrafts and the unmanned aerial vehicle 800; and determine the aircraft corresponding to the maximum collision coefficient among the multiple aircrafts as the target aircraft.

In some embodiments, the processor 802 is also configured to determine the collision coefficient between the target aircraft and the unmanned aerial vehicle 800 according to the flight status information of the target aircraft.

When determining the duration configuration parameters of the communication connection between the ADS-B device 801 and the two antennas in the first state and in the second state according to the relative direction, the radiation patterns of the two antennas, and the protocol type of the ADS-B signal from the target aircraft, the processor 802 is specifically configured to, when the collision coefficient between the target aircraft and the unmanned aerial vehicle is greater than or equal to the fourth preset collision coefficient, determine the duration configuration parameters of the communication connection between the ADS-B device 801 and the two antennas in the first state and in the second state according to the relative direction, the radiation patterns of the two antennas, and the protocol type of the ADS-B signal from the target aircraft.

In some embodiments, the processor 802 is also configured to, when the collision coefficient between the target aircraft and the unmanned aerial vehicle 800 is less than the fourth preset collision coefficient, determine that the duration configuration parameters of the communication connection between the ADS-B device 801 and the two antennas in the first state and in the second state are the same duration configuration parameter.

In some embodiments, the processor 802 also includes a switch 805.

The processor 802 is specifically configured to control the ADS-B device to communicatively connect to the two antennas in the first state and in the second state in turn through the switch 805.

In some embodiments, the ADS-B signal from the target aircraft includes the ADS-B signal based on the UAT protocol.

The processor 802 is specifically configured to control the ADS-B device 801 to communicatively connect to the two antennas in the first state and in the second state in turn within the guard time interval of the signal frame of the ADS-B signal based on the UAT protocol.

The unmanned aerial vehicle of the present disclosure can be used to implement the technical solutions of FIG. 5 and the corresponding method thereof, and the implementation principle and technical effect thereof are similar, which will not be repeated herein.

One of ordinary skill in the art can understand that all or part of the processes in the method of the embodiments described above can be implemented by a program instructing relevant hardware, and the program can be stored in a computer readable storage medium. When the program is executed, the processes in the method of the embodiments are executed. The storage medium includes a read-only memory (ROM), a random access memory (RAM), a magnetic disk, an optical disk, or another medium that can store program codes.

Finally, it should be noted that the embodiments described above are only used to illustrate the technical solutions of the present disclosure rather than limiting them. Although the present disclosure has been described in detail with reference to all the described embodiments, those of ordinary skill in the art should understand that the technical solutions in all the described embodiments can still be modified, or some or all of the technical features can be equivalently replaced. The modifications or replacements do not cause the essence of the corresponding technical solutions to depart from the scope of the technical solutions in the embodiments of the present disclosure.

What is claimed is:

1. A method for controlling an unmanned aerial vehicle comprising:
obtaining flight status information of a target aircraft;
determining a relative direction of the target aircraft relative to the unmanned aerial vehicle according to the flight status information of the target aircraft; and
communicatively connecting an automatic dependent surveillance broadcast (ADS-B) device of the unmanned aerial vehicle to a target antenna selected from a plurality of antennas of the unmanned aerial vehicle according to the relative direction and radiation patterns of the plurality of antennas, so that the ADS-B device obtains and analyzes an ADS-B signal from the target aircraft received by the target antenna;
wherein the radiation patterns of the plurality of antennas are different from each other.

2. The method of claim 1, wherein communicatively connecting the ADS-B device to the target antenna includes:
determining radiation gains of the plurality of antennas in a radiation direction corresponding to the relative direction according to the relative direction and the radiation patterns of the plurality of antennas; and
communicatively connecting the ADS-B device to the target antenna according to the radiation gains of the plurality of antennas in the radiation direction corresponding to the relative direction.

3. The method of claim 2, wherein communicatively connecting the ADS-B device to the target antenna of the plurality of antennas according to the radiation gains of the plurality of antennas in the radiation direction corresponding to the relative direction includes:
determining a maximum radiation gain from the radiation gains of the plurality of antennas in the radiation direction corresponding to the relative direction; and
communicatively connecting the ADS-B device to one of the plurality of antennas that corresponds to the maximum radiation gain.

4. The method of claim 2, wherein communicatively connecting the ADS-B device to the target antenna of the plurality of antennas according to the radiation gains of the plurality of antennas in the radiation direction corresponding to the relative direction includes:
determining duration configuration parameters of communication connections between the ADS-B device and the plurality of antennas according to the radiation gains of the plurality of antennas in the radiation direction corresponding to the relative direction; and
communicatively connecting the ADS-B device to each of the plurality of antennas in turn according to the duration configuration parameters.

5. The method of claim 4, wherein the radiation gain of an antenna in the radiation direction corresponding to the relative direction is positively correlated with the duration configuration parameter of the communication connection between the ADS-B device and the antenna.

6. The method of claim 4, wherein each of the duration configuration parameters includes a duration or a duration ratio.

7. The method of claim 4, further comprising:
comprising determine a collision coefficient between the target aircraft and the unmanned aerial vehicle according to the flight status information of the target aircraft;
wherein determining the duration configuration parameters includes, in response to the collision coefficient being greater than or equal to a preset collision coefficient, determining the duration configuration parameters of the communication connections between the ADS-B device and the plurality of antennas according to the radiation gains of the plurality of antennas in the radiation direction corresponding to the relative direction.

8. The method of claim 7, further comprising:
in response to the collision coefficient being less than the preset collision coefficient, determining the duration configuration parameters to be a same preset duration configuration parameter.

9. The method of claim 1,
wherein obtaining the flight status information of the target aircraft includes obtaining flight status information of a plurality of aircrafts, the status information of the plurality of aircrafts including the status information of the target aircraft;
the method further comprising:
determining a collision coefficient between each of the plurality of aircrafts and the unmanned aerial vehicle according to the flight status information of the plurality of aircraft; and
determining the target aircraft from the plurality of aircrafts according to the collision coefficients of the plurality of aircrafts.

10. The method of claim 9, wherein determining the target aircraft from the plurality of aircrafts according to the collision coefficients includes:
determining a maximum collision coefficient from the collision coefficients; and
determining one of the plurality of aircrafts that corresponds to the maximum collision coefficient as the target aircraft.

11. The method of claim 1, further comprising:
determining a collision coefficient between the target aircraft and the unmanned aerial vehicle according to the flight status information of the target aircraft;
wherein determining the relative direction includes, in response to the collision coefficient being greater than or equal to a preset collision coefficient, determining the relative direction of the target aircraft according to the flight status information of the target aircraft.

12. The method of claim 1, wherein communicatively connecting the ADS-B device to the target antenna includes establishing a communication connection between the ADS-B device and the target antenna through a switch.

13. The method of claim 1, wherein the ADS-B device includes at least one of a universal access transceiver (UAT) mode receiver or a mode S extended squitter transponder (1090ES) mode receiver.

14. The method of claim 13, wherein the ADS-B device includes the UAT mode receiver and the 1090ES mode receiver, each of the plurality of antennas including a dual-frequency antenna.

15. The method of claim 1, wherein:
the ADS-B device includes a universal access transceiver (UAT) mode receiver, and the ADS-B signal from the target aircraft includes an ADS-B signal based on a UAT protocol; and
communicatively connecting the ADS-B device to the target antenna includes communicatively connecting the ADS-B device to the target antenna within a guard time interval of a signal frame of the ADS-B signal based on the UAT protocol.

16. An unmanned aerial vehicle comprising:
a plurality of antennas;
an automatic dependent surveillance broadcast (ADS-B) device configured to analyze an ADS-B signal from a target aircraft to obtain flight status information of the target aircraft; and
a processor configured to:
obtain the flight status information of the target aircraft;
determine a relative direction of the target aircraft relative to the unmanned aerial vehicle according to the flight status information of the target aircraft; and
communicatively connect the ADS-B device to a target antenna of the plurality of antennas according to the relative direction and radiation patterns of the plurality of antennas, so that the ADS-B device obtains and analyzes the ADS-B signal from the target aircraft received by the target antenna;
wherein the radiation patterns of the plurality of antennas are different from each other.

17. The unmanned aerial vehicle of claim 16, wherein the processor is further configured to:
determine radiation gains of the plurality of antennas in a radiation direction corresponding to the relative direction according to the relative direction and the radiation patterns of the plurality of antennas; and
communicatively connect the ADS-B device to the target antenna according to the radiation gains of the plurality of antennas in the radiation direction corresponding to the relative direction.

18. The unmanned aerial vehicle of claim 17, wherein the processor is further configured to:
determine a maximum radiation gain from the radiation gains of the plurality of antennas in the radiation direction corresponding to the relative direction; and
communicatively connect the ADS-B device to one of the plurality of antennas that corresponds to the maximum radiation gain.

19. The unmanned aerial vehicle of claim 17, wherein the processor is further configured to:
determine duration configuration parameters of communication connections between the ADS-B device and the plurality of antennas according to the radiation gains of the plurality of antennas in the radiation direction corresponding to the relative direction; and
communicatively connect the ADS-B device to each of the plurality of antennas in turn according to the duration configuration parameters.

20. The unmanned aerial vehicle of claim 19, wherein the radiation gain of an antenna in the radiation direction corresponding to the relative direction is positively correlated with the duration configuration parameter of the communication connection between the ADS-B device and the antenna.
